(19) United States
(12) Patent Application Publication
(10) Pub. No.: US 2017/0171809 A1
(43) Pub. Date: Jun. 15, 2017

(54) WIRELESS ACCESS POINT POWER SAVE MODE

(71) Applicant: Lenovo Enterprise Solutions (Singapore) Pte. Ltd., Singapore (SG)

(72) Inventors: John S. Crowe, Durham, NC (US); Jennifer J. Lee-Baron, Morrisville, NC (US); Nathan J. Peterson, Durham, NC (US); Amy L. Rose, Chapel Hill, NC (US); Bryan L. Young, Tualatin, OR (US)

(21) Appl. No.: 14/963,664

(22) Filed: Dec. 9, 2015

(51) Int. Cl. H04W 52/02; H04W 48/16

(52) U.S. Cl. CPC H04W 52/0206; H04W 48/16

(57) ABSTRACT

A method includes a wireless access point (WAP) automatically entering a power save mode in response to inactivity, wherein the power save mode includes powering off a transmitter of a WAP and reducing power to a processor and a receiver of the WAP. The method further includes periodically enabling the receiver to monitor for a probe request from a client device while the WAP is in the power save mode. Still further, the method includes automatically exiting the power save mode and entering an awake mode in response to receiving a probe request frame from a client device while the WAP is in the power save mode, wherein the awake mode includes powering on the transmitter of the WAP and increasing power to the processor and receiver of the WAP.

### BACKGROUND

Field of the Invention

The present invention relates to the operation of a wireless access point.

Background of the Related Art

A wireless access point (AP), which may follow the WiFi™ standard for wireless local area networks (WLANs), is a device that allows one or more wireless client devices to connect with a wired network. Accordingly, wireless client devices include smartphones, notebook computers and table computers that may be used to make a wireless connection to the wired network. Such a wireless connection may be sought for the purpose of accessing a website, obtaining email, or making a call using Voice Over Internet Protocol (VOIP). Wireless access points have been widely implemented in customer-oriented businesses and public places due in part to an increase in the performance and availability of wireless client devices.

A typical wireless access point will remain fully energized unless managed by a schedule, controlled by a management controller over a wired connection, or manually turned off and on. Powering down the access point, or even moving to a lower power state, while the access point is connected to a wireless client would create a latency that most users of the wireless client would not tolerate.

### BRIEF SUMMARY

One embodiment of the present invention provides a method comprising a wireless access point automatically entering a wireless access point power save mode in response to inactivity of the wireless access point, wherein the wireless access point power save mode includes powering off a transmitter of a wireless access point and reducing power to a processor and a receiver of the wireless access point. The method further comprises periodically enabling the receiver to monitor for a probe request from a client device while the wireless access point is in the wireless access point power save mode. Still further, the method comprises automatically exiting the wireless access point power save mode and entering a wireless access point awake mode in response to receiving a probe request frame from a client device while the wireless access point is in the wireless access point power save mode, wherein the wireless access point awake mode includes powering on the transmitter of the wireless access point and increasing power to the processor and receiver of the wireless access point.

Another embodiment of the present invention provides a computer program product for operating a wireless access point, the computer program product comprising a non-transitory computer readable storage medium having program instructions embodied therewith, the program instructions executable by a processor to cause the processor to perform a method. The method comprises a wireless access point automatically entering a wireless access point power save mode in response to inactivity of the wireless access point, wherein the wireless access point power save mode includes powering off a transmitter of a wireless access point and reducing power to a processor and a receiver of the wireless access point. The method further comprises periodically enabling the receiver to monitor for a probe request from a client device while the wireless access point is in the wireless access point power save mode. Still further, the method comprises automatically exiting the wireless access point power save mode and entering a wireless access point awake mode in response to receiving a probe request frame from a client device while the wireless access point is in the wireless access point power save mode, wherein the wireless access awake mode includes powering on the transmitter of the wireless access point and increasing power to the processor and receiver of the wireless access point.

Yet another embodiment of the present invention provides an apparatus comprising a wireless router including a wireless access point, and a computer program product for operating the wireless access point. The computer program product comprises a non-transitory computer readable storage medium having program instructions embodied therewith, the program instructions executable by a processor to cause the processor to perform a method. The method may be any of the methods described herein.

### BRIEF DESCRIPTION OF THE SEVERAL VIEWS OF THE DRAWINGS

FIG. 1 is a diagram of a system including a wireless access point.

FIG. 2 is a diagram of a wireless client in communication with a wireless access point.

FIG. 3 is a sequence diagram illustrating the steps in establishing a connection between a wireless client and a wireless access point.

FIG. 4 is an example of code included in a probe request frame sent from a wireless client.

FIG. 5 is a diagram of a system including a wireless mesh network.

FIG. 6 is a flowchart of a method according to one embodiment of the present invention.

### DETAILED DESCRIPTION

One embodiment of the present invention provides a method comprising a wireless access point automatically entering a wireless access point power save mode in response to inactivity of the wireless access point, wherein the wireless access point power save mode includes powering off a transmitter of a wireless access point and reducing power to a processor and a receiver of the wireless access point. The method further comprises periodically enabling the receiver to monitor for a probe request from a client device while the wireless access point is in the wireless access point power save mode. Still further, the method comprises automatically exiting the wireless access point power save mode and entering a wireless access point awake mode in response to receiving a probe request frame from a client device while the wireless access point is in the wireless access point power save mode, wherein the wireless access point awake mode includes powering on the transmitter of the wireless access point and increasing power to the processor and receiver of the wireless access point.

A wireless access point (WAP) is a device that allows a wireless client device to connect to a wired network using a wireless local area network (WLAN) technology, such as Wi-Fi® or other technology based on the Institute of Electrical and Electronics Engineers (IEEE) 802.11 standard. A wireless access point includes a radio transmitter and a radio receiver that enable communication with a wireless client device. A wireless client will also have a radio transmitter and radio receiver, such as may be found in a wireless network interface controller (WNIC). Accordingly, the wireless client and wireless access point may communicate over one or more channels. Typically, a wireless client will establish a connection with a wireless access point in order to gain access to the wired network, such that the wireless client may obtain various forms of content or services, such as websites, audio, video, and email.

The wireless client may scan for, and discover, one or more wireless devices, including one or more wireless access points. The process of discovering an access point may include the client device transmitting a probe request and then listening for a probe response. Conversely, the access point may listen for a probe request and then, in response to receiving a probe request, transmit a probe response. The content of the probe request and the probe response may vary, but may include information identifying the transmitting station and describing the capabilities of the transmitting station.

The wireless access point may determine inactivity in any configurable manner and the present invention is not limited to any one or more criteria or threshold for determining inactivity. However, since the wireless access point will power off its transmitter in response to inactivity of the wireless access point, one preferred measure of inactivity is a lack of any connection between the wireless access point and a client device. Accordingly, when there is no client device with which to transmit data, then the wireless access point may power off its transmitter. However, it is within the scope of the present invention that the transmitter may be used, even when the wireless access point is in the power save mode, to periodically transmit a beacon frame.

As set out above, the method includes exiting the wireless access point power save mode in response to receiving a probe request frame from a client device while the wireless access point is in the wireless access point power save mode. However, in one embodiment, the foregoing exiting step may include exiting the wireless access point power save mode in response to receiving a probe request frame that includes an identifier matching an identifier stored by the wireless access point. Accordingly, not all probe requests will cause the wireless access point to exit the power save mode. For example, the identifier stored by the wireless access point is selected from a basic service set identifier (BSSID) associated with the wireless access point, a service set identifier (SSID) associated with the wireless access point, or a media access control (MAC) address of the client device.

In yet another embodiment, the wireless access point may operate in a mesh network with a plurality of other wireless access points. It is preferable that each of the wireless access points in the mesh network is enabled with a power save mode in accordance with one or more embodiment of the present invention. Optionally, the method may associate the client device with the wireless access point storing the identifier that matches the identifier in the probe request, and cause the wireless access point to use a backhaul radio to establish a connection through one or more of the plurality of other wireless access points back to a wired network.

A mesh network is a communications network made up of multiple radio nodes, such as the wireless access points, in a mesh topology, such that each of the radio nodes cooperate in the distribution of data over the network. A mesh network may or may not be fully connected, meaning that it is not necessary that each radio node connect with every other radio node. A message may be propagated between two devices on the network by hopping from node to node.

Optionally, processor power management may include the use of power states. For example, the step of reducing power to a processor of the wireless access point may include causing the processor to enter a lower power state, and the step of increasing power to the processor of the wireless access point may include causing the processor to enter a higher power state.

Another embodiment of the present invention provides a computer program product for operating a wireless access point, the computer program product comprising a computer readable storage medium having non-transitory program instructions embodied therewith, the non-transitory program instructions executable by a processor to cause the processor to perform a method. The method comprises a wireless access point automatically entering a wireless access point power save mode in response to inactivity of the wireless access point, wherein the wireless access point power save mode includes powering off a transmitter of a wireless access point and reducing power to a processor and a receiver of the wireless access point. The method further comprises periodically enabling the receiver to monitor for a probe request from a client device while the wireless access point is in the wireless access point power save mode. Still further, the method comprises automatically exiting the wireless access point power save mode and entering a wireless access point awake mode in response to receiving a probe request frame from a client device while the wireless access point is in the wireless access point power save mode, wherein the wireless access awake mode includes powering on the transmitter of the wireless access point and increasing power to the processor and receiver of the wireless access point.

The foregoing computer program products may further include non-transitory program instructions for implementing or initiating any one or more aspects of the methods described herein. Accordingly, a separate description of the methods will not be duplicated in the context of a computer program product.

Yet another embodiment of the present invention provides an apparatus comprising a wireless router including a wireless access point, and a computer program product for operating the wireless access point. The computer program product comprises a computer readable storage medium having non-transitory program instructions embodied therewith, the non-transitory program instructions executable by a processor to cause the processor to perform a method. The method may be any of the methods described herein.

A still further embodiment of the present invention provides an apparatus comprising a wireless access point, and a computer program product for operating the wireless access point. The computer program product comprises a computer readable storage medium having non-transitory program instructions embodied therewith, the non-transitory program instructions executable by a processor to cause the processor to perform a method. The method may be any of the methods described herein.

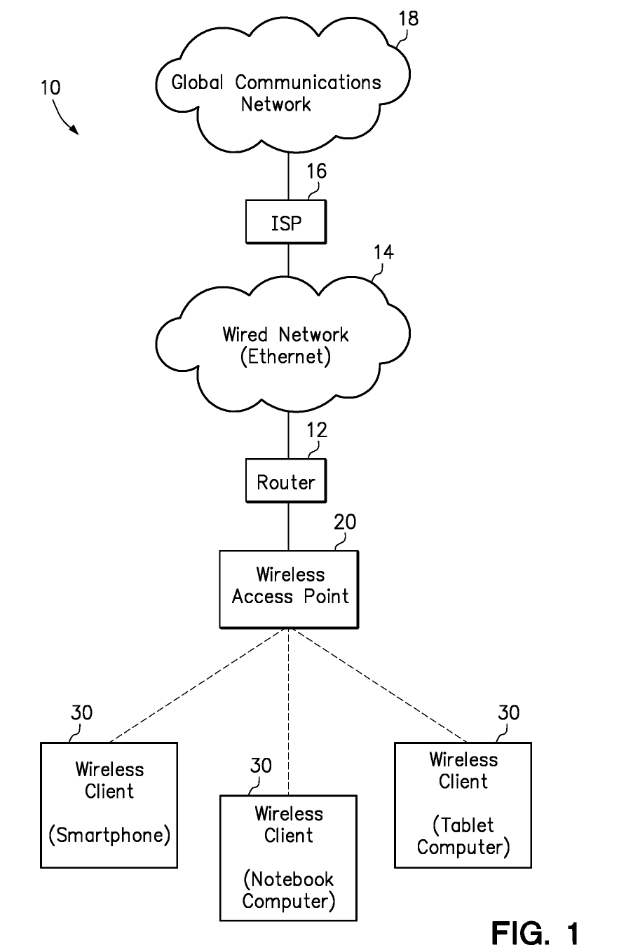

FIG. 1 is a diagram of a system 10 including a wireless access point 20 and multiple wireless clients 30. The dashed lines are used to indicate a wireless connection between the wireless clients 30 and the wireless access point 20. For example, the wireless clients 30 may include a smartphone, notebook computer and table computer enabled for wireless communication. By connecting to the wireless access point 20, each wireless client 30 may communicate with each other wireless client or gain access to a wired network. In this non-limiting illustration, the wireless access point 20 is in wired communication through with router 12 that, in turn, is in wired communication with a wired network 14, such as an Ethernet network. Optionally, the wired network 14 may be further connected to an Internet Service Provider (ISP) 16 that provides access to a global communication network 18, such as the Internet. In some instance, the wireless access point 20 may be included in an integrated device along with the router 12.

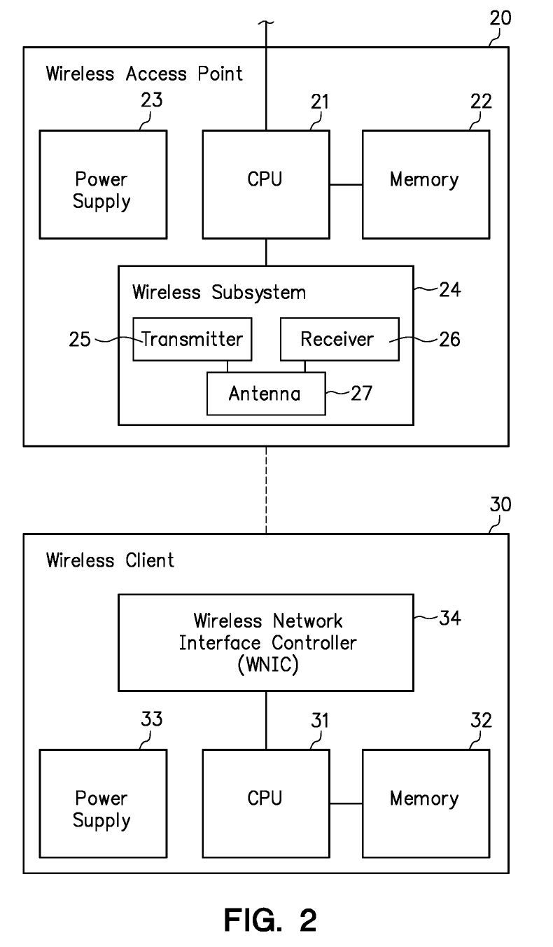

FIG. 2 is a diagram of a wireless client 30 in communication with a wireless access point 20. Other components of the system 10 in FIG. 1 have been omitted from FIG. 2 in order to focus on the components and operation of a single wireless client and wireless access point. As shown, the wireless access point 20 includes a central processor unit (CPU) 21, memory 22 and a wireless subsystem 24, each of which receive power from a power supply 23. The wireless subsystem 24 includes a transmitter 25, receiver 26, and an antenna 27. It should be recognized that the wireless access point 20 include further components, including additional transmitters, receivers and antennas.

The wireless client 30 includes a central processor unit (CPU) 31, memory 22 and a wireless network interface controller (WNIC) 34, each of which receive power from a power supply 33. The wireless network interface controller 34 provides the components and capability of wirelessly transmitting and receiving data to and from the wireless access point. Embodiments of the present invention include methods of operating the wireless access point 20 in order to reduce the amount of power consumed by the wireless access point during periods of activity.

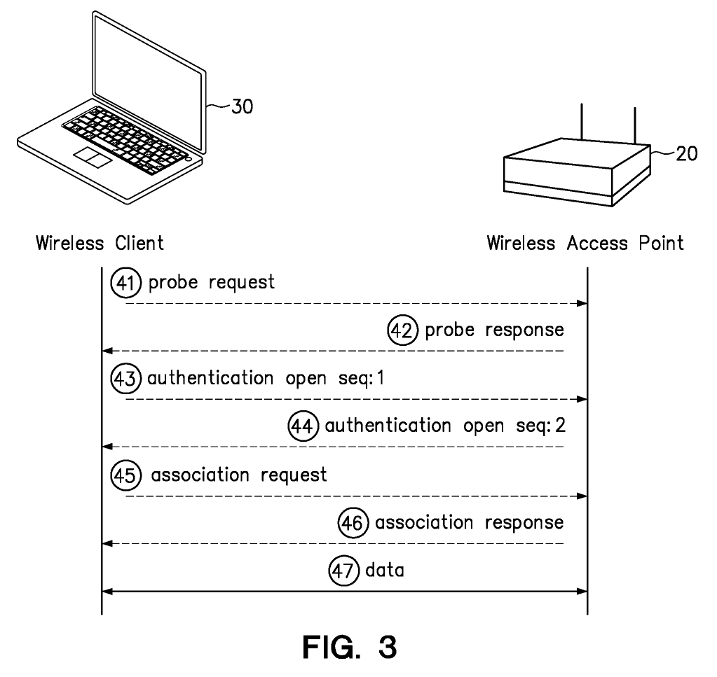

FIG. 3 is a sequence diagram illustrating the steps in establishing a connection between a wireless client 30 and a wireless access point 20. In step 41, the wireless client transmits a probe request frame that is received by the wireless access point. In step 42, the wireless access point then sends with a probe response frame to the wireless client. Steps 43 and 44 include transmitting an authentication frame from the wireless client to the wireless access point, and transmitting an authentication frame from the wireless access point to the wireless client. Then, steps 45 and 46 include transmitting an association request frame from the wireless client to the wireless access point, and transmitting an association response frame from the wireless access point to the wireless client. If the devices are compatible and the authentication and association are accepted by the wireless access point, then data frames may be exchanged between the wireless client and the wireless access point in step 47.

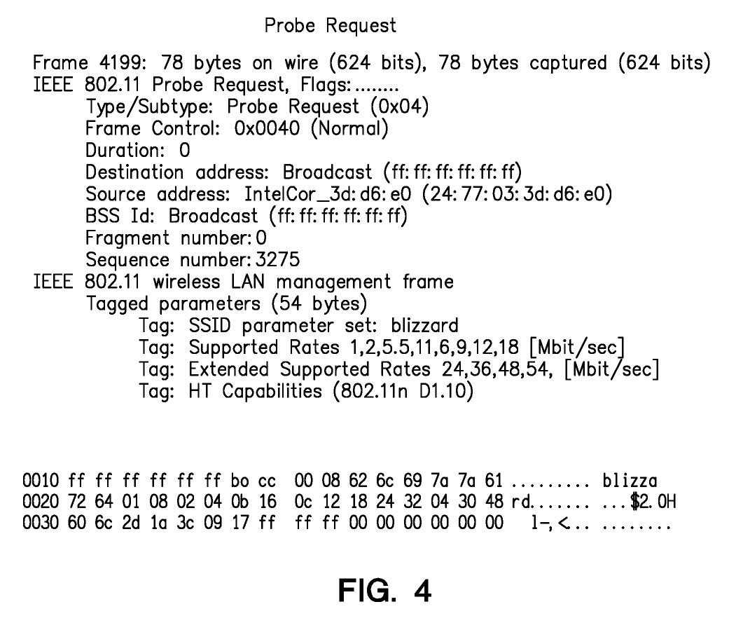

FIG. 4 is a non-limiting example of code included in a probe request frame sent from a wireless client. As illustrated, the probe request frame includes a wireless access point's MAC Address (BSSID), which in this case it does not know, so it uses the broadcast address “ff: ff: ff: ff: ff: ff”. The probe request further includes the wireless network (SSID), which is “blizzard”, and the wireless client's MAC address, “24:77:03:3d:d6:e0”.

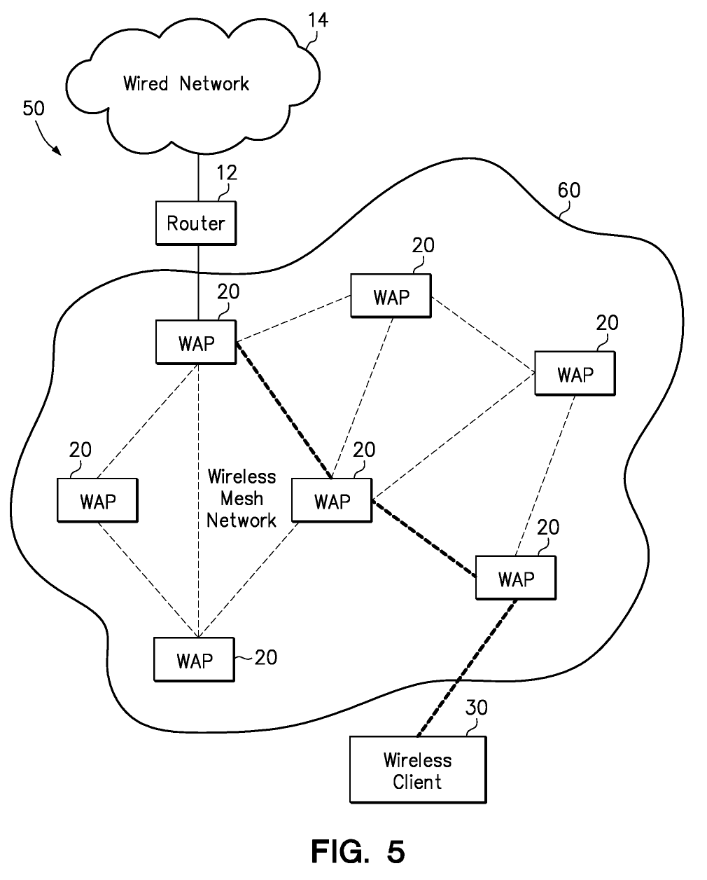

FIG. 5 is a diagram of a system 50 including a wireless mesh network 60. The system 50 is similar to the system 10 in FIG. 1, except that the single wireless access point 20 shown in FIG. 1 has been replaced with the wireless mesh network 60. The wireless mesh network 60 includes multiple wireless access points 20 and may include other wireless clients. The wireless client 30 has established a wireless connection with a particular wireless access point 20. If the wireless client 30 seeks access to the wired network 14, the particular wireless access point 20 will route the communication via one or more other wireless access points 20 in the wireless mesh network 60 until the communication reaches the wired network. It should be appreciated that such a communication may be routed through a small number of the wireless access points, rather than flooding the communication to each and every wireless access point in the wireless mesh network. One such route or path has been highlighted with bold dashed lines. Accordingly, many of the wireless access points in the wireless mesh network may be inactive even while other wireless access points in the wireless mesh network may be active.

The utility of establishing wakeup criteria, such as matching MAC ID, BSSID, or SSID, is evident in the mesh network. Without such criteria, a probe request might wake up multiple access points, which may then wake up other access points in order to gain access to the physical network. Using the matching criteria as a condition for establishing a connection limits how many access points will wake up and increase power consumption.

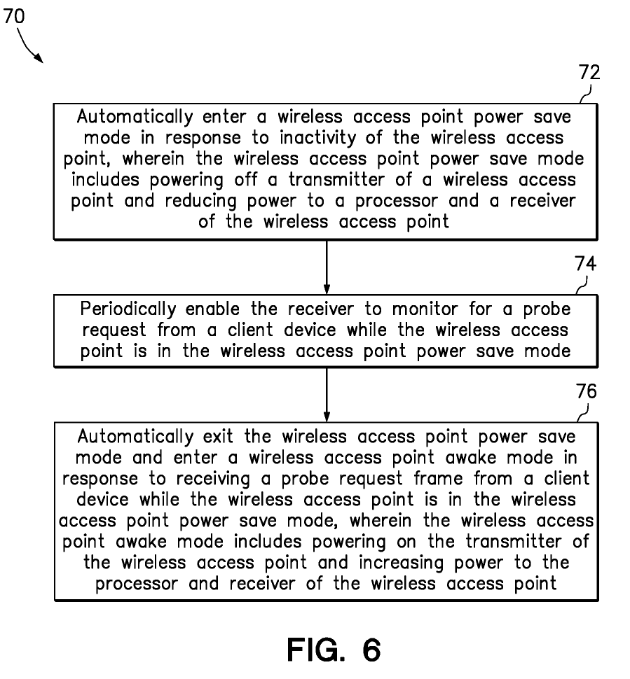

FIG. 6 is a flowchart of a method 70 according to one embodiment of the present invention. In step 72, the method automatically enters a wireless access point power save mode in response to inactivity of the wireless access point, wherein the wireless access point power save mode includes powering off a transmitter of a wireless access point and reducing power to a processor and a receiver of the wireless access point. In step 74, the method periodically enables the receiver to monitor for a probe request from a client device while the wireless access point is in the wireless access point power save mode. In step 76, the method automatically exits the wireless access point power save mode and enters a wireless access point awake mode in response to receiving a probe request frame from a client device while the wireless access point is in the wireless access point power save mode, wherein the wireless access awake mode includes powering on the transmitter of the wireless access point and increasing power to the processor and receiver of the wireless access point.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, comprising:
a wireless access point automatically entering a wireless access point power save mode in response to inactivity of the wireless access point, wherein the wireless access point power save mode includes powering off a transmitter of a wireless access point and reducing power to a processor and a receiver of the wireless access point;
periodically enabling the receiver to monitor for a probe request from a client device while the wireless access point is in the wireless access point power save mode; and
automatically exiting the wireless access point power save mode and entering a wireless access point awake mode in response to receiving a probe request frame from a client device while the wireless access point is in the wireless access point power save mode, wherein the wireless access awake mode includes powering on the transmitter of the wireless access point and increasing power to the processor and the receiver of the wireless access point.

2. The method of claim 1, wherein exiting the wireless access point power save mode in response to receiving a probe request frame from a client device while the wireless access point is in the wireless access point power save mode, includes
exiting the wireless access point power save mode in response to receiving a probe request frame that includes an identifier matching an identifier stored by the wireless access point.

3. The method of claim 2, wherein the identifier stored by the wireless access point is selected from a basic service set identifier associated with the wireless access point, a service set identifier associated with the wireless access point, or a media access control address of the client device.

4. The method of claim 3, wherein the wireless access point operates in a mesh network with a plurality of other wireless access points.

5. The method of claim 4, further comprising:
associating the client device with the wireless access point storing the identifier that matches the identifier in the probe request; and
the wireless access point using a backhaul radio to establish a connection through one or more of the plurality of other wireless access points back to a wired network.

6. The method of claim 1, wherein the reducing power to a processor of the wireless access point includes causing the processor to enter a lower power state, and wherein increasing power to the processor of the wireless access point include causing the processor to enter a higher power state.

7. The method of claim 1, wherein the inactivity of the wireless access point is a lack of a connection between the wireless access point and a client device.

8. A computer program product for operating a wireless access point, the computer program product comprising a non-transitory computer readable storage medium having program instructions embodied therewith, the non transitory program instructions executable by a processor to cause the processor to perform a method comprising:
automatically entering a wireless access point power save mode in response to inactivity of the wireless access point, wherein the wireless access point power save mode includes powering off a transmitter of a wireless access point and reducing power to a processor and a receiver of the wireless access point;
periodically enabling the receiver to monitor for a probe request from a client device while the wireless access point is in the wireless access point power save mode; and
automatically exiting the wireless access point power save mode and entering a wireless access point awake mode in response to receiving a probe request frame from a client device while the wireless access point is in the wireless access point power save mode, wherein the wireless access awake mode includes powering on the transmitter of the wireless access point and increasing power to the processor and receiver of the wireless access point.

9. The computer program product of claim 8, wherein exiting the wireless access point power save mode in response to receiving a probe request frame from a client device while the wireless access point is in the wireless access point power save mode, includes
exiting the wireless access point power save mode in response to receiving a probe request frame that includes an identifier matching an identifier stored by the wireless access point.

10. The computer program product of claim 9, wherein the identifier stored by the wireless access point is selected from a basic service set identifier associated with the wireless access point, a service set identifier associated with the wireless access point, or a media access control address of the client device.

11. The computer program product of claim 10, wherein the wireless access point operates in a mesh network with a plurality of other wireless access points.

12. The computer program product of claim 11, further comprising:
associating the client device with the wireless access point storing the identifier that matches the identifier in the probe request; and
the wireless access point using a backhaul radio to establish a connection through one or more of the plurality of other wireless access points back to a wired network.

13. The computer program product of claim 8, wherein the reducing power to a processor of the wireless access point includes causing the processor to enter a lower power state, and wherein increasing power to the processor of the wireless access point include causing the processor to enter a higher power state.

14. The computer program product of claim 8, wherein the inactivity of the wireless access point is a lack of a connection between the wireless access point and a client device.

15. An apparatus, comprising:
a wireless router including a wireless access point; and
the computer program product of claim 8.
